(19) United States
(12) Patent Application Publication
(10) Pub. No.: US 2006/0108064 A1
(43) Pub. Date: May 25, 2006

(54) Laser weldable thermoplastic polymer composition and process for laser welding

(76) Inventor: Hiroshi Mori, Tochigi (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/281,545

(22) Filed: Nov. 17, 2005

Related U.S. Application Data
(60) Provisional application No. 60/630,763, filed on Nov. 24, 2004.

(51) Int. Cl. B32B 37/00

(52) U.S. Cl. 156/272.8

(57) ABSTRACT

Thermoplastic polymer compositions capable of being colored and suitable for use in laser welding applications and a process for laser welding objects made therefrom.

### CROSS REFERENCE TO RELATED APPLICATION

This application claims the benefit of U.S. Provisional Application No. 60/630,763 filed Nov. 24, 2004.

### FIELD OF THE INVENTION

The present invention relates to thermoplastic polymer compositions capable of being colored and suitable for use in laser welding applications. The invention further relates to a process for laser welding objects comprising the thermoplastic polymer compositions.

### BACKGROUND OF THE INVENTION

It is often desired to produce molded plastic parts that can be mechanically assembled into more complex parts. Traditionally, plastic parts have been assembled by gluing or bolting them together or using snap-fit connections. These methods suffer from the drawback that they can add complicated additional steps to the assembly process. Snap-fit connections are often not gas- and liquid-tight and require complex designs. Newer techniques are vibration and ultrasonic welding, but these can also require complex part designs and welding apparatuses. Additionally, the friction from the process can generate dust that can contaminate the inside of the parts. This is a particular problem when sensitive electrical or electronic components are involved.

A more recently developed technique is laser welding. In this method, two polymeric objects to be joined have different levels of light transmission at the wavelength of the laser that is used. One object is at least partially transparent to the wavelength of the laser light (and referred to as the “relatively transparent” object), while the second part absorbs a significant portion of the incident radiation (and is referred to as the “relatively opaque” object). Each of the objects presents a faying surface and the relatively transparent object presents an impinging surface, opposite the faying surface thereof. The faying surfaces are brought into contact, thus forming a juncture. A laser beam is directed at the impinging surface of the relatively transparent object such that it passes through the first object and irradiates the faying surface of the second object, causing the first and second objects to be welded at the juncture of the faying surfaces. See generally U.S. Pat. No. 5,893,959, which is hereby incorporated by reference herein. This process can be very clean, simple, and fast and provides very strong, easily reproducible welds and significant design flexibility.

A disadvantage to laser welding is that the relatively opaque object must comprise materials that absorb light at the wavelength of the laser light. The laser light absorbing materials are typically pigments such as carbon black or black dyes such a nigrosine. The presence of these materials typically renders the relatively opaque object black, even when colorants of other colors are also present. However, it is often desired that the relatively opaque part of laser-welded articles have a natural color or be colored with a color, including white, other than black. Thus, it would be desirable to obtain a polymer composition that could be used in its natural color or a color other than black to form the relatively opaque object used in a laser welding process.

U.S. Patent Application publication 2003/0130381 discloses thermoplastic molding compositions comprising laser-transparent thermoplastic material and one or more selected IR-absorbing compounds, wherein the compositions have a carbon black content of less than 0.1 weight percent.

### SUMMARY OF THE INVENTION

Briefly stated, and in accordance with one aspect of the present invention, there is provided a polymer composition, comprising:
(a) about 17 to about 99.5 weight percent of a thermoplastic polymer;
(b) about 0.003 to about 0.05 weight percent of carbon black; and
(c) about 0.4 to about 10 weight percent of a mineral selected from one or more of titanium dioxide, zinc sulfide, and zinc oxide;
(d) 0 to about 70 weight percent of reinforcing agents and/or mineral fillers;
(e) 0 to about 70 weight percent of additives; and
(f) 0 to about 3 weight percent of one or more colorants,

wherein the above-stated weight percentages are based on the total weight of the composition.

Pursuant to another aspect of the present invention, there is provided a process for welding a first polymeric object to second polymeric object using laser radiation, wherein said first polymeric object is relatively transparent to said laser radiation and said second object is relatively opaque to said laser radiation, said first and said second objects each presenting a faying surface, said first object presenting an impinging surface, opposite said faying surface thereof, said process comprising the steps of (1) bringing the faying surfaces of said first and second objects into physical contact so as to form a juncture therebetween and (2) irradiating said first and second objects with said laser radiation such that said laser radiation impinges the impinging surface, passes through said first object and irradiates said faying surface of said second object, causing said first and second objects to be welded at the juncture of the faying surfaces, wherein said second polymeric object is formed from a thermoplastic polymer composition comprising:
(a) about 17 to about 99.5 weight percent of a thermoplastic polymer;
(b) about 0.003 to about 0.05 weight percent of carbon black; and
(c) about 0.4 to about 10 weight percent of a mineral selected from one or more of titanium dioxide, zinc sulfide, and zinc oxide;
(d) 0 to about 70 weight percent of reinforcing agents and/or mineral fillers;
(e) 0 to about 70 weight percent of additives; and
(f) 0 to about 3 weight percent of one or more colorants,
   wherein the above-stated weight percentages are based on the total weight of the composition.

Pursuant to another aspect of the present invention, there is provided an article made from the above composition that includes but are not limited to: housings for electrical or electronic sensors, toys, medical devices and parts for printers, copiers, or fax machines. Another aspect of the present invention are laser welded articles made by the above process that include but are not limited to: housings for electrical or electronic sensors, toys, medical devices and parts for printers, copiers, or fax machines.

### BRIEF DESCRIPTION OF THE DRAWINGS

The invention will be more fully understood from the following detailed description, taken in connection with the accompanying drawings, in which:

FIG. 1 is a side elevation of test piece 11 used herein to determine laser weldability and measure weld strength.

FIG. 2 is a top plane view of test piece 11 used herein to determine laser weldability and measure weld strength.

FIG. 3 is a perspective view of test piece 11 used herein to determine laser weldability and measure weld strength.

FIG. 4 is a perspective view of relatively transparent test piece 11′, and relatively opaque test piece 11″, wherein the faying surfaces of the respective test pieces are placed into contact and positioned to be laser welded together.

FIG. 5 is a perspective view of relative transparent test piece 32 and relatively opaque test piece 30 used herein to determine laser weldability when welded to form test bar 38.

FIG. 6 is an exploded view of test pieces 40 and 42, wherein test piece 42 is shown in cross-section.

FIG. 7 is a cross-sectional view of relatively transparent test piece 42 and relatively opaque test piece 40 placed into contact and positioned to be laser welded together.

FIG. 8 is top view of test piece 42.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

The composition of the present invention comprises at least one thermoplastic polymer, about 0.003 to about 0.05 weight percent carbon black, and about 0.5 to about 10 weight percent of a mineral selected from one or more of titanium dioxide, zinc sulfide, and zinc oxide. The composition of the present invention is capable of being colored and may be used to form a non-black relatively opaque object used in a laser welding process. The composition is used either in its natural color or containing colorants such as dyes and/or pigments that impart a color to the composition other than black. By “capable of being colored” is meant that when containing a suitable amount of non-black colorants, the composition possesses a color, including white, that is other than black. By “natural color” is meant the color of the composition without the addition of dyes, pigments, or other colorants other than the said carbon black and mineral selected from one or more of titanium dioxide, zinc sulfide, and zinc oxide.

Examples of suitable thermoplastic polymers include, but are not limited to polyacetals, polyesters, liquid crystalline polyesters, polyamides, polycarbonates, acrylanitrile-butadiene-styrene polymers (ABS), poly(phenylene oxide)s, poly(phenylene sulfide)s, polysulphones, polyarylates, polyetheretherketones (PEEK), polyetherketoneketones (PEKK), polystyrenes, syndiotactic polystyrenes, polyethylene, polypropylene. Preferred are polyacetals, polyesters, and polyamides.

The polyacetal can be one or more homopolymers, copolymers, or a mixture thereof. Homopolymers are prepared by polymerizing formaldehyde and/or formaldehyde equivalents, such as cyclic oligomers of formaldehyde. Copolymers are derived from one or more comonomers generally used in preparing polyacetals in addition to formaldehyde and/or formaldehyde equivalents. Commonly used comonomers include acetals and cyclic ethers that lead to the incorporation into the polymer chain of ether units with 2-12 sequential carbon atoms. If a copolymer is selected, the quantity of comonomer will not be more than 20 weight percent, preferably not more than 15 weight percent, and most preferably about two weight percent. Preferable comonomers are 1,3-dioxolane, ethylene oxide, and butylene oxide, where 1,3-dioxolane is more preferred, and preferable polyacetal copolymers are copolymers where the quantity of comonomer is about 2 weight percent. It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the comonomer unit or are terminated with ether groups. Preferred end groups for homopolymers are acetate and methoxy and preferred end groups for copolymers are hydroxy and methoxy.

Suitable thermoplastic polyamides can be condensation products of dicarboxylic acids and diamines, and/or aminocarboxylic acids, and/or ring-opening polymerization products of cyclic lactams. Suitable dicarboxylic acids include adipic acid, azelaic acid, sebacic acid, dodecanedioic acid, isophthalic acid, and terephthalic acid. Suitable diamines include tetramethylenediamine, hexamethylenediamine, octamethylenediamine, nonamethylenediamine, dodecamethylenediamine, decamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. A suitable aminocarboxylic acid is 11-aminododecanoic acid. Suitable cyclic lactams are caprolactam and laurolactam. Preferred polyamides include aliphatic polyamide such as polyamide 6; polyamide 6,6; polyamide 4,6; polyamide 6,10; polyamide 6,12; polyamide 11; polyamide 12; and semi-aromatic polyamides such as poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethyleneadipamide-hexamethyleneterephthalamide copolyamide (polyamide 6,T/6,6), hexamethyleneterephthalamide-2-methylpentamethyleneterephthalamide copolyamide (polyamide 6,T/D,T); and copolymers and mixtures of these polymers.

Preferred thermoplastic polyesters (which have mostly, or all, ester linking groups) are normally derived from one or more dicarboxylic acids (or their derivatives such as esters) and one or more diols. In preferred polyesters the dicarboxylic acids comprise one or more of terephthalic acid, isophthalic acid and 2,6-naphthalene dicarboxylic acid, and the diol component comprises one or more of HO(CH₂)ₙOH (I), 1,4-cyclohexanedimethanol, HO(CH₂CH₂O)ₘCH₂CH₂OH (II), and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and since m and z are averages, they do not have to be integers. Other diacids, which may be used to form the thermoplastic polyester, include sebacic and adipic acids. Hydroxycarboxylic acids such as hydroxybenzoic acid may be used as comonomers. Specific preferred polyesters include poly(ethylene terephthalate) (PET), poly(1,3-propylene terephthalate) (PPT), poly(1,4-butylene terephthalate) (PBT), poly(ethylene 2,6-napthoate), poly(1,4-cylohexyldimethylene terephthalate) (PCT), a thermoplastic elastomeric polyester having poly(1,4-butylene terephthalate) and poly(tetramethyleneether)glycol blocks (available as Hytrel® from E.I. DuPont de Nemours & Co., Inc., Wilmington, Del. 19898 USA) and copolymers of any of these polymers with any of the above mentioned diols and/or dicarboxylic acids. Suitable polyesters also include liquid crystalline polyesters.

The thermoplastic polymer is present in about 17 to about 99.5 weight percent, or preferably in about 25 to about 99 weight percent, based on the total weight of the composition.

The composition comprises about 0.003 to about 0.05 weight percent, or preferably about 0.003 to about 0.04 weight percent, or more preferably about 0.003 to about 0.01 weight percent of carbon black, based on the total weight of the composition.

The composition further comprises about 0.4 to about 10 weight percent, or preferably about 1 to about 5 weight percent of a mineral selected from one or more of titanium dioxide, zinc sulfide, and zinc oxide.

The composition may optionally further comprise up to about to about 3.0 weight percent, or preferably, about 0.01 to 1 weight percent, of one or more colorants. Preferred colorants include pigments and dyes. The colorants are preferably not black. Preferred dyes include phthalocyanine, azo (including monoazom and azomethine), anthroquinone, naphtaloimide, methine, dioxadine, perylene, perinone, quinoline, benzanthrone, quinacridone, and benzimidazolone dyes, and the like.

The composition of the present invention may optionally include, in addition to the above components, additives such as nucleating agents, heat stabilizers, antioxidants, UV light stabilizers, lubricants, mold-release agents, flame retardants and impact modifiers. The composition may optionally also further include reinforcing agents such as glass fibers and/or mineral fillers.

When used, additives will be present in about 0 to about 70 weight percent, or preferably about 5 to about 50 weight percent, based on the total weight of the composition. When used, mineral fillers and reinforcing agents will be present in about 0 to about 70 weight percent, or preferably about 5 to about 50 weight percent, based on the total weight of the composition.

The compositions of the present invention are in the form of a melt-mixed blend, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method. The component materials may be mixed using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed. The sequence of mixing in the manufacture of the compositions of the invention may be such that individual components may be melted in one shot, or the filler and/or other components may be fed from a side feeder, and the like, as will be understood by those skilled in the art.

The compositions of the present invention may be formed into objects using methods known to those skilled in the art, such as, for example, injection molding, blow molding, injection blow molding, or extrusion. The objects comprising the composition of the present invention may be laser welded to other objects and may be either the relatively transparent object or, preferably, the relatively opaque object in the laser welding process, or both. Preferred lasers for use in the laser welding process of the present invention are any lasers emitting light having a wavelength within the range of about 800 nm to about 1200 nm. Examples of types of preferred lasers are YAG and diode lasers.

The relatively transparent object used in the laser welding process may have a natural color or may contain dyes that are sufficiently transparent to the wavelength of light used for laser welding. Such dyes may include, for example, anthraquinone-based dyes.

The present invention also includes any laser-welded article made from the process of the invention. Useful articles are automobile parts such as electrical and electronic sensor housings; parts for office equipment such as printers, copiers, fax machines, and the like; parts for industrial equipment such as conveyor; parts for medical devices; and parts for consumer goods such as toys and sporting goods.

### EXAMPLES

Preparation of Samples

The compositions used in the examples and comparative examples were prepared by melt-blending the ingredients shown in Tables 1 and 2 in a single screw extruder.

In Table 1, “polyacetal” refers to Delrin® 460, a polyacetal copolymer supplied by E.I. du Pont de Nemours and Co., Wilmington, Del. In Table 2, “polyamide” refers to Zytel®101L NC010, a polyamide 6,6 supplied by E.I. du Pont de Nemours and Co., Wilmington, Del. In Table 1, “blue pigment” refers to phthalocyanine blue and “violet pigment” refers to dioxadine violet pigment.

The compositions were molded into test bars for laser welding. The color of the resulting bars was evaluated visually and is indicated in Tables 1 and 2.

Laser Weld Strength

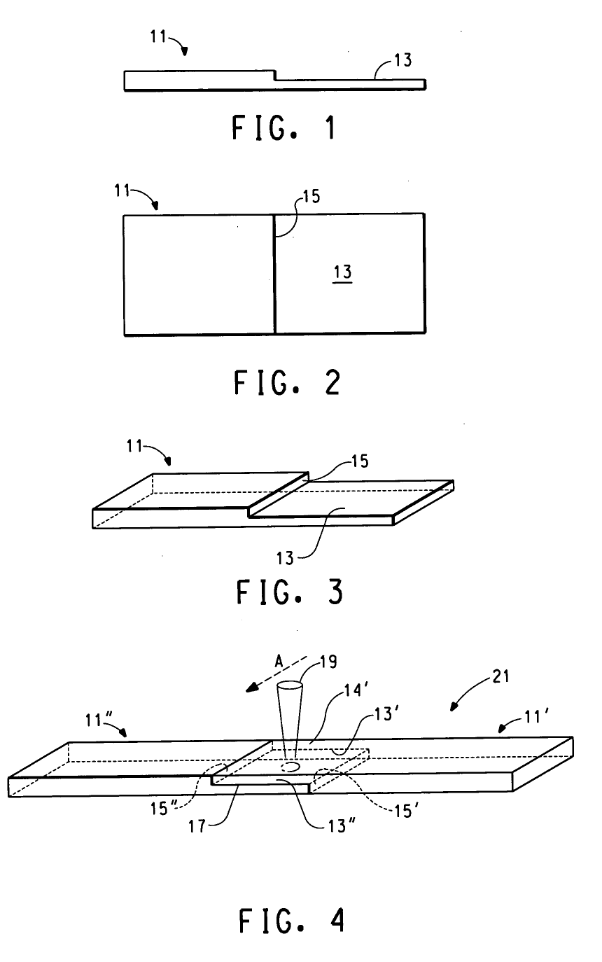

FIGS. 1-3 disclose the geometry of a typical test piece 11 that was used to measure laser weldability and weld strength as reported herein for Examples 2-9 and Comparative Examples 2-6. Test piece 11 was generally rectangular in shape, having dimensions of 70 mm×18 mm×3 mm and a 20 mm deep half lap at one end. The half lap is defined by faying surface 13 and riser 15.

In FIG. 4, test piece 11′ is a relatively transparent polymeric test piece and test piece 11″ is a relatively opaque polymeric test piece, each test piece (11′ and 11″) having the form and dimensions of the typical test piece 11 described above. The faying surfaces 13′ and 13″ of test pieces 11′ and 11″, respectively, were placed into contact so as to form juncture 17 therebetween. Relatively transparent test piece 11′ defines an impinging surface 14′ that is impinged by laser radiation 19 moving in the direction of arrow A. Laser radiation 19 passed through relatively transparent test piece 11′ and irradiated the faying surface 13″ of relatively opaque test piece 11″ and thereby caused pieces 11′ and 11″ to be welded together at juncture 17 so as to form test bar 21.

### Examples 2-9 and Comparative Examples 2-6:

Resin compositions corresponding to Examples 2-9 and Comparative Examples 2-6 were molded into relatively opaque test pieces 11″. In the case of Examples 2-4 and Comparative Examples 2-5, Delrin® 460 was molded into relatively transparent test pieces 11′. In the case of Examples 5-10 and Comparative Example 6, Zytel® 101L NC010 was molded into relatively transparent test pieces 11′.

In each case, test pieces 11′ and 11″ were welded together as described above with a clamped pressure of 0.3 MPa to form a test bar 21. The laser radiation was emitted from a Rofin-Sinar Laser GmbH 940 nm diode laser. The laser beam was focused to a diameter of 3 mm and was passed once along the width of test pieces 11′ and 11″ at the rates indicated in Tables 1 and 2 under the heading “welding rate.” The laser power was varied between about 50 and 455 W.

The force required to separate the 11′ and 11″ test pieces of the resulting test bars 21 was determined using an Shimadzu Autograph tester manufactured by Shimadzu Seisakusho clamped at the shoulder of the test bars, wherein tensile force was applied in the longitudinal direction of test bars. The tester was operated at a rate of 2 mm/min. If a force of greater than 1 kgf was required to separate the test pieces, they were deemed to be laser weldable as indicated in Tables 1 and 2. If no adhesion between the test pieces occurred during laser welding, they were considered to have no laser weldability as indicated in Tables 1 and 2. The power providing the optimal weld strength for each composition is given in Tables 1 and 2 under the heading of “laser power.” The resulting weld strength is given in Tables 1 and 2 under the heading of “laser weld strength.”

### Comparative Example 1

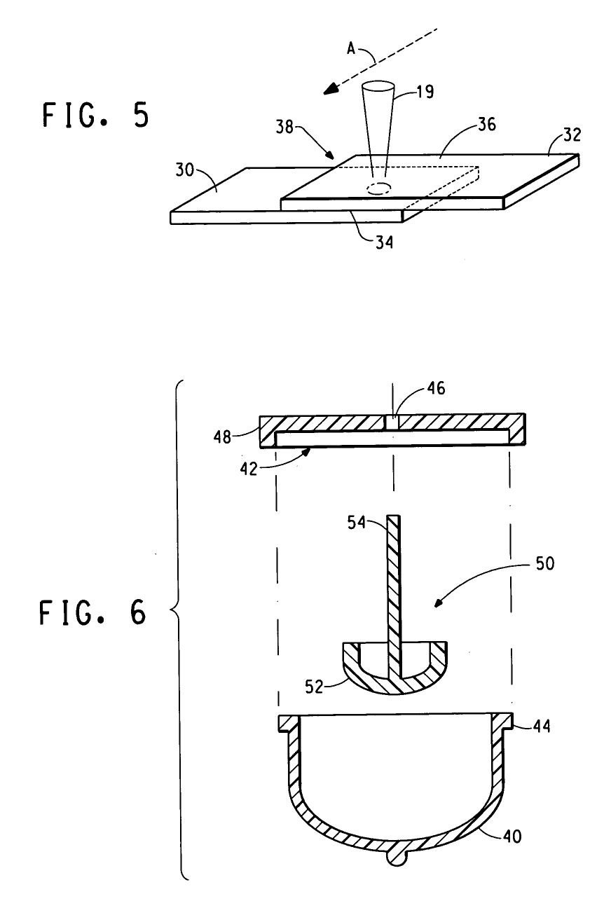

FIG. 5 discloses the geometry of relatively opaque test piece 30 molded from the composition of Comparative Example 1 that was used to measure laser weldability and weld strength as reported herein for Comparative Example 1. Test piece 30 was generally rectangular in shape, having dimensions of 40 mm×20 mm×3.2 mm. FIG. 5 also discloses the geometry of relatively transparent test piece 32 also used to measure laser weldability and weld strength as reported herein for Comparative Example 1. Test piece 32 was molded from Delrin® 460 and was generally rectangular in shape, having dimensions of 40 mm×20 mm×1.6 mm. The test pieces were overlapped with their surfaces in contact with each other to form juncture 34 therebetween and clamped with a pressure of 0.3 MPa. Relatively transparent test piece 32 defines an impinging surface 36 that is impinged by laser radiation 19 moving in the direction of arrow A. Laser radiation 19 passed through relatively transparent test piece 32 and irradiated the surface of relatively opaque test piece 30 and thereby it was attempted to cause pieces 30 and 32 to be welded together at juncture 34 so as to form test bar 38. The laser radiation was emitted from a Rofin-Sinar Laser GmbH 940 nm diode laser. The laser beam was focused to a diameter of 3 mm and passed once along the width of 30 and 32 at a rate of between 50 and 500 cm/min and at a power of 200 W. The laser welding was unsuccessful and at none of the rates tried was a bond formed between pieces 30 and 32.

### Example 1

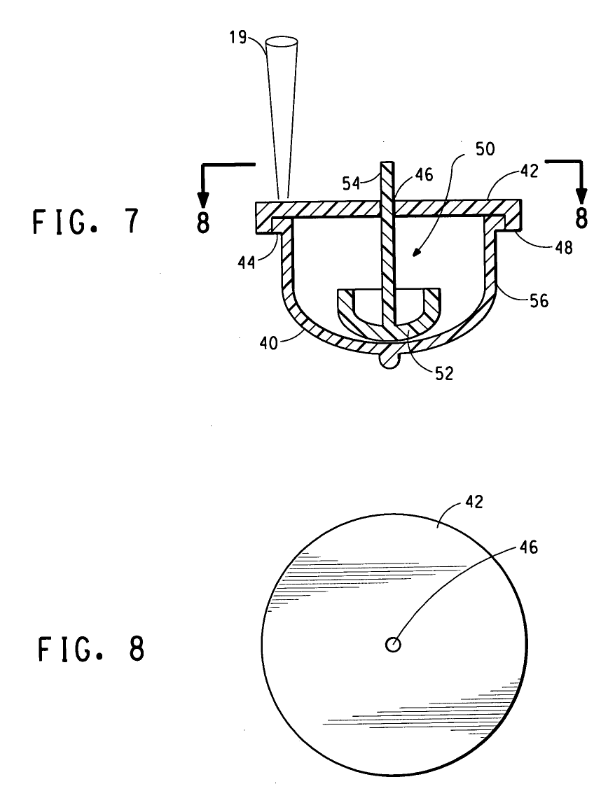

FIGS. 6 and 7 discloses the geometry of a relatively opaque test piece 40 molded from the composition of Example 1. Test piece 40 was in the form of a round open bowl-like object serving as the base of a toy top and having a lip 44. FIGS. 6-8 disclose the geometry of relatively transparent test piece 42 molded from Delrin® 460. Test piece 42 is a disc serving as the lid of a toy top and having a central opening 46 and a lip 48. Reference number 50 refers to a spinner of a toy top that has a base 52 and a stem 54. Base 52 was inserted into test piece 40 and piece 42 was placed on top of piece 40 such that stem 54 passes through opening 46 and that the bottom surface of piece 42 was in contact with the upper surface of lip 44.

With continuing reference to FIGS. 6 and 7, test piece 42 was clamped to piece 40 with a pressure of 0.3 MPa. Laser radiation 19 was passed through relatively transparent piece 42 at the point where piece 42 contacted lip 44 and irradiated the surface of relatively opaque piece 40 causing pieces 40 and 42 to become welded to form test piece 56 in the form of a toy top. During the welding process, the laser radiation was passed radially once around piece 42 such that its motion described a circle at a rate of 150 cm/min. The laser radiation was emitted from a Rofin-Sinar Laser GmbH 940 nm diode laser. The laser beam was focused to a diameter of 0.3 mm and operated at a power of 30 W.

Weld strength was measured by clamping test piece 56 in a cylindrical steel jig and applying force in a downward direction onto stem 54 using a Shimadzu Autograph tester manufactured by Shimadzu Seisakusho. The force necessary to separate welded test pieces 40 and 42 is shown in Table 1.

It is therefore, apparent that there has been provided in accordance with the present invention, a laser weldable thermoplastic polymer composition and process for laser welding that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

TABLE 1

| | Ex. 1 | Ex. 2 | Ex. 3 | Ex. 4 | Comp. Ex. 1 | Comp. Ex. 2 | Comp. Ex. 3 | Comp. Ex. 4 | Comp. Ex. 5 |
|---|---|---|---|---|---|---|---|---|---|
| Polyacetal | 98.5 | 99.5 | 99.5 | 99 | 99 | 100 | 99.9 | 99 | 99.5 |
| Titanium dioxide | 0.5 | 0.5 | 0.5 | 1 | 0.17 | 0 | 0 | 1 | 0.5 |
| Carbon black | 0.005 | 0.005 | 0.003 | 0.003 | 0.004 | 0 | 0.1 | 0.001 | 0.001 |
| Blue pigment | 0.95 | — | — | — | 0.4 | — | — | — | — |
| Violet pigment | 0.05 | — | — | — | — | — | — | — | — |
| Part color | blue | gray | light gray | light gray | blue | white | black | very | very |
| | | | | | | | | light gray | light gray |
| Welding rate | 150 | 200 | 200 | 200 | 50-500 | 200 | 200 | 200 | 200 |
| (cm/min) | | | | | | | | | |
| Laser weldable | yes | yes | yes | yes | no | no | yes | no | no |
| Laser weld strength | 341 | 111 | 104 | 108 | 0 | 0 | 133 | 0 | 0 |
| (kgf) | | | | | | | | | |
| Laser power (W) | 30 | 400 | 400 | 400 | 200 | 250-400 | 300 | 250-400 | 250-400 |

Ingredient quantities are given in weight percent relative to the total weight of the composition.

TABLE 2

| | Ex. 5 | Ex. 6 | Ex. 7 | Ex. 8 | Ex. 9 | Ex. 10 | Comp. Ex. 6 |
|---|---|---|---|---|---|---|---|
| Polyamide | 99.5 | 99 | 99.5 | 99 | 95 | 95 | 99.9 |
| Titanium dioxide | 0.5 | 1 | 0.5 | 1 | 5 | 5 | 0 |
| Carbon black | 0.005 | 0.005 | 0.003 | 0.003 | 0.005 | 0.003 | 0.1 |
| Part color | light gray | light gray | Light gray | light gray | white | white | black |
| Welding rate | 200 | 200 | 200 | 200 | 200 | 200 | 500 |
| (cm/min) | | | | | | | |
| Laser weldable | yes | yes | yes | yes | yes | yes | yes |
| Laser weld strength | 54 | 106 | 38 | 55 | 123 | 115 | 131 |
| (kgf) | | | | | | | |
| Laser power (W) | 160 | 180 | 400 | 250 | 200 | 300 | 80 |

Ingredient quantities are given in weight percent relative to the total weight of the composition.

What is claimed is:

1. A polymer composition, comprising:
(a) about 17 to about 99.5 weight percent of a thermoplastic polymer;
(b) about 0.003 to about 0.05 weight percent of carbon black; and
(c) about 0.4 to about 10 weight percent of a mineral selected from one or more of titanium dioxide, zinc sulfide, and zinc oxide;
(e) 0 to about 70 weight percent of reinforcing agents and/or mineral fillers;
(e) 0 to about 70 weight percent of additives; and
(f) 0 to about 3 weight percent of one or more colorants,
wherein the above-stated weight percentages are based on the total weight of the composition.

2. The composition of claim 1, further comprising about 0.01 to about 1.0 weight percent of one or more colorants.

3. The composition of claim 1, wherein the thermoplastic polymer is one or more of polyamide, polyacetal, or polyester.

4. The composition of claim 3, wherein the polyamide is one or more of polyamide 6; polyamide 6,6; polyamide 4,6; polyamide 6,10; polyamide 6,12; polyamide 11; polyamide 12; polyamide MXD,6, polyamide 12,T, polyamide 10,T, polyamide 9,T, polyamide 6,T/6,6, or polyamide 6,T/D,T.

5. The composition of claim 3, wherein the polyester is one or more of poly(ethylene terephthalate) (PET), poly(1,3-propylene terephthalate) (PPT), poly(1,4-butylene terephthalate) (PBT), poly(ethylene 2,6-napthoate), or poly(1,4-cylohexyldimethylene terephthalate) (PCT).

6. The composition of claim 1, further comprising about 5 to about 50 weight percent of one or more reinforcing agents or mineral fillers.

7. The composition of claim 1, further comprising about 5 to about 50 weight percent of one or more additives.

8. An article comprising the composition of claim 1.

9. The article of claim 9, in the form of a housing for electrical or electronic sensors.

10. The article of claim 9, in the form of a toy.

11. The article of claim 9, in the form of a medical device.

12. A process for welding a first polymeric object to second polymeric object using laser radiation, wherein said first polymeric object is relatively transparent to said laser radiation and said second object is relatively opaque to said laser radiation, said first and said second objects each presenting a faying surface, said first object presenting an impinging surface, opposite said faying surface thereof, said process comprising the steps of (1) bringing the faying surfaces of said first and second objects into physical contact so as to form a juncture therebetween and (2) irradiating said first and second objects with said laser radiation such that said laser radiation impinges the impinging surface, passes through said first object and irradiates said faying surface of said second object, causing said first and second objects to be welded at the juncture of the faying surfaces, wherein said second polymeric object is formed from a thermoplastic polymer composition comprising:
(a) about 17 to about 99.5 weight percent of a thermoplastic polymer;
(b) about 0.003 to about 0.05 weight percent of carbon black; and
(c) about 0.4 to about 10 weight percent of a mineral selected from one or more of titanium dioxide, zinc sulfide, and zinc oxide;
(d) 0 to about 70 weight percent of reinforcing agents and/or mineral fillers;
(e) 0 to about 70 weight percent of additives; and
(f) 0 to about 3 weight percent of one or more colorants,
wherein the above-stated weight percentages are based on the total weight of the composition.

13. The process of claim 12, wherein the thermoplastic polymer composition further comprises about 0.01 to about 1 weight percent of one or more colorants.

14. The process of claim 12, wherein the thermoplastic polymer is one or more of polyamide, polyacetal, or polyester.

15. The process of claim 12, wherein the polyamide is one or more of polyamide 6; polyamide 6,6; polyamide 4,6; polyamide 6,10; polyamide 6,12; polyamide 11; polyamide 12; polyamide MXD,6, polyamide 12,T, polyamide 10,T, polyamide 9,T, polyamide 6,T/6,6, or polyamide 6,T/D,T.

16. The process of claim 14, wherein the polyester is one or more of poly(ethylene terephthalate) (PET), poly(1,3-propylene terephthalate) (PPT), poly(1,4-butylene terephthalate) (PBT), poly(ethylene 2,6-napthoate), or poly(1,4-cylohexyldimethylene terephthalate) (PCT).

17. The process of claim 12, wherein the thermoplastic polymer composition further comprises about 5 to about 50 weight percent of one or more reinforcing agents or mineral fillers.

18. The process of claim 12, wherein the thermoplastic polymer composition further comprises about 5 to about 50 weight percent of one or more additives.

19. A laser welded article made by the process of claim 12.

20. The laser welded article of claim 19, in the form of a housing for electrical or electronic sensors.

21. The laser welded article of claim 19, in the form of a toy.

22. The laser welded article of claim 19, in the form of a part for a printer, copier, or fax machine.

23. The laser welded article of claim 19, in the form of a medical device.
